(19) United States
(12) Patent Application Publication
(10) Pub. No.: US 2009/0160695 A1
(43) Pub. Date: Jun. 25, 2009

(54) Remote control apparatus

(75) Inventor: Toshikazu Yokota, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (KR)

(21) Appl. No.: 12/292,501

(22) Filed: Nov. 20, 2008

(30) Foreign Application Priority Data
Dec. 21, 2007 (JP) 2007-330543

(51) Int. Cl. H04L 17/02; G06F 3/048

(52) U.S. Cl. 341/176; 715/810

(57) ABSTRACT

A remote control apparatus is disclosed that includes a display unit, a remote control unit, and a controller. The controller is configured to: causes the display unit to display multiple select switch image items over an image; divide the image into multiple regions in correspondence with the multiple select switch image items; specify an operation position existing region as corresponding to one of the multiple regions that the operation position is positioned in; and configured to cause one select switch image items corresponding to the operation position existing region to appear as being in a selectable status. When the controller receives a select switch selection command from the remote control unit, the controller is configured to determine that the one select switch image item being in the selectable status is selected and the controller is configured to issue a device operation command.

### CROSS REFERENCE TO RELATED APPLICATION

The present application is based on Japanese Patent Application No. 2007-330543 filed on Dec. 21, 2007, the disclosure of which is incorporated herein by reference.

### BACKGROUND OF THE INVENTION

1. Field of the Invention

The present invention relates to a remote control apparatus for remote-controlling various apparatus by, for example, selecting a switch image item displayed over an image.

2. Description of Related Art

A navigation system is known that can be remote-controlled with a remote controller or the like. A remote control method is known that includes the followings. A pointer is displayed on an image in accordance with a position of an operation knob, and allows an operation on the image. The use of the above remote control method allows software for navigation with a touch-sensitive system and software for remote control to be common, and may cause efficient development of software (cf. JP-A-2004-252760).

There is also known a navigation system that utilizes multiple drawing systems to display an image for use in navigation as well as another image that is obtained from a camera mounted to a vehicle, and that represents a surrounding of the vehicle. The inventor has revealed that the following difficulties arise when a remote system is developed on the basis of a known navigation technique with a touch-sensitive system. An apparatus including multiple drawing systems involves a case where a pointer is required to be displayed on a new layer, but it is not always possible to display such a new layer. That is, the apparatus involves a drawing system that does not display a new layer. In such a case, since it is not possible to display a pointer on a screen, a user needs to perform an operation through the screen in a state where the pointer is not displayed on the screen. Accordingly, a system is provided with remarkable worse usability.

### SUMMARY OF THE INVENTION

In view of the above and other points, it is an objective of the present invention to provide a remote control apparatus.

According to a first aspect of the present invention, a remote control apparatus is provided that includes a display unit, a remote control unit, a receiving unit, and a controller. The display unit is capable of displaying an image and a multiple select switch image items each to be selected for a device operation. The remote control unit is configured to issue an operation position command and a select switch selection command in accordance with a user's movement operation of a selecting position. The operation position command instructs an operation position on the image displayed by the display unit. The select switch selection command instructs a selection operation for selecting a target select switch image from among the multiple select switch image items. The receiving unit is configured to receive the operation position command and the select switch selection command from the remote control unit. The controller is configured to issue a device operation command based on the operation position command and the select switch selection command input form the receiving unit. The controller is configured to causes the display unit to display the multiple select switch image items over the image, and configured to divide the image into multiple regions in correspondence with the multiple select switch image items. The controller is configured to obtain the operation position command through the receiving unit, configured to specify an operation position existing region as corresponding to one of the multiple regions that the operation position instructed by the operation position command is positioned in, and configured to cause one of the multiple select switch image items corresponding to the operation position existing region to appear as being in a selectable status. When the controller receives the select switch selection command through the receiving unit in a state where the one of the multiple select switch image items corresponding to the operation position existing region appears as being in a selectable status, the controller is configured to determine that the one of the multiple select switch image items is selected and the controller is configured to issue the device operation command.

According to the above remote control apparatus, it is possible to provide the remote control apparatus with a high operability.

According to a second aspect of the present invention, a remote control apparatus for an in-vehicle system is provided. The remote control apparatus includes a display unit that has a screen capable of displaying an image and multiple menu items. The remote control apparatus further includes a remote control unit that has an input interface capable of receiving an input operation, and that is configured to outputs a remote control signal that depends on the input operation. The remote control apparatus further includes a receiving unit that is configured to receive the remote control signal from the remote control unit and output the remote control signal. The remote control apparatus further includes a controller that is configured to receive the remote control signal from the receiving unit, configured to control display on the screen of the display unit, and capable of outputting a system control signal for controlling the in-vehicle system based on the remote control signal. The controller is configured to cause the display unit to display the image. The controller is configured to cause the display unit to display the multiple menu items over the image. The controller is configured to set a virtual coordinate system for specifying a position on the image, and set a virtual operation point that has a position on the virtual coordinate system. The virtual operation point is movable on the virtual coordinate system in accordance with the remote control signal. The controller is configured to specify a position of each menu item on the virtual coordinate system. The controller is configured to partition the virtual coordinate system into multiple regions so that the multiple menu items are respectively positioned in the multiple regions. The controller is configured to specify an operation point existing region as corresponding to one of the multiple regions that the virtual operation point is positioned in. The controller is configured to cause the display unit to display one of the multiple menu items that corresponds to the operation point existing region as being in a selectable status. The controller is configured to issue the system control signal when the one of the multiple menu items is in the selectable status and when the remote control signal indicates that the input interface receives a predetermined input operation.

According to the above remote control apparatus, it is possible to provide the remote control apparatus with a high operability.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram illustrating a navigation system for a vehicle in accordance with an example embodiment;

FIG. 2 is a flow chart illustrating a selection control procedure in accordance with an example embodiment;

FIG. 3A is a diagram illustrating display example of select switch image items in accordance with the prior art; and

FIG. 3B is a diagram illustrating display example of select switch image items in accordance with an example embodiment.

### DETAILED DESCRIPTION OF THE EXEMPLARY EMBODIMENTS

Exemplary embodiments are described below with reference to the accompanying drawings.

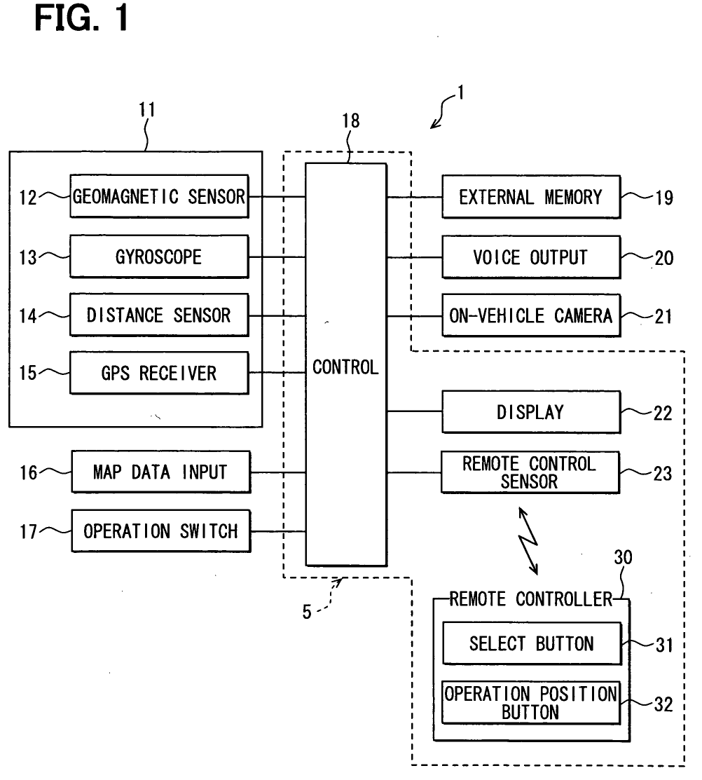

FIG. 1 is a block diagram illustrating a navigation system 1 for a vehicle in accordance with the present embodiments. As shown in FIG. 1, the navigation system 1 for a vehicle includes a position detection apparatus 11, a map data input unit 16, an operation switch group unit 17, an external memory unit 19, voice output unit 20, an on-vehicle camera unit 21, and a remote control apparatus 5.

The position detection apparatus 11 includes a geomagnetic sensor unit 12, gyroscope unit 13, a distance sensor unit 14, and a GPS receiver unit 15. Since the above multiple units 12, 13, 14, 15 have different types of errors, the navigation system 1 is configured such that a position of the subject vehicle is detected by compensating errors with the multiple units. Depending on desired accuracy, the position detection apparatus 11 may include one or more of the above units 12, 13, 14, 15, or may further utilize a rotation sensor for a steering wheel or a tire sensor for each tire wheel.

The map data input unit 16 is for inputting various data to improve position detection accuracy. The various data include map data, landmark data, and data for map-matching. A storage medium may be a CD-ROM or a DVD. Alternatively, the storage medium may be a memory card or a HDD.

The operation switch group unit 17 can be used for operating the navigation system 1 by a user (e.g., a driver). The operation switch group unit 17 may be provided by, for example, touch-sensitive switches integrated with the display unit 22 or mechanical switches.

The external memory unit 19 may be a HDD device or a memory stick. The external memory unit 19 can store various data including, for example, sound data and personal information of a driver. The sound data provides an output from the voice output unit 20. The personal information of a driver can be used for making various setting for the navigation system 1.

The voice output unit 20 includes a speaker (not shown) and an audio-amplifier (not shown). The voice to be output from the voice output unit 20 may be provided by the data stored in the external memory unit 19, or may be provided by data synthesized in a control unit 18.

Alternatively, the above-described voice output unit 20 may be omitted from an element of the navigation system 1 for a vehicle. In such a case, another device such as an in-vehicle audio device can be used as an element that functions as the voice output device.

An on-vehicle camera unit 21 is mounted to a vehicle, and can obtain an image of a road on which the subject vehicle is traveling or an image of a surrounding of the subject vehicle. The on-vehicle camera unit 21 may include a CCD camera having a small size.

The remote control apparatus 5 includes a display unit 22, a remote control sensor unit 23, a remote control unit 30, and the control unit 18 (i.e., controller 18). The display unit 22 includes a LCD or an organic electroluminescence display, and can provide color display. The display unit 22 can display multiple select switch image items, which are to be selected for a device operation.

Further, the display unit 22 can display an image item associated with additional data over an image. The image item may be: a mark indicating the present position of the subject vehicle; a map image associated with the map data inputted from the map data input unit 16; or a navigation (or guidance) route to be displayed over the map image.

The remote control sensor unit 23 receives an infrared signal transmitted from the remote control unit 30, the infrared signal including an operation position command and a select switch selection command. The remote control unit 30 can be used for selecting the select switch image item displayed on the display unit 22 by a movement operation of a selecting position by a user and a selection operation of a select switch image item by the user. In accordance with the movement operation of the selecting position, the remote control unit 30 is configured to change a displacement speed of the operation position on the image over which the select switch image item is displayed.

Further, in accordance with the user's movement operation of the selecting position, the remote control unit 30 issues an operation position command, which instructs the operation position on the image over which the select switch image items are displayed, and a select switch selection command for selecting a target select switch image item.

More specifically, the remote control unit 30 has a select button 31 at a center portion of the remote control unit 30. The select button 31 can be used for selecting the select switch image item. The remote control unit 30 further has operation position buttons 32, which are respectively located on the right side, the left side, the top side and the bottom side of the select button 31. The operation position buttons 32 can be used for inputting the selecting position. The operation position button located on the top side of the select button 31 is also referred to as a first operation position button 32. The operation position buttons located on the left side, the button side, the right side of the select button 31 are also referred to as second, third, fourth operation position buttons 32, respectively. The select button 31 and the operation position buttons 32 are example elements of an input interface of the remote control unit 30.

When the select button 31 is pressed, the select switch selection command is issued. When the operation position button 32 is pressed, the operation position command is issued. When the first operation position button 32 is pressed, the operation position command is issued so that the operation position is slightly moved upward during the first operation position button 32 is being pressed. When the first operation position button 32 is pressed twice in order, the operation position command issued instructs an uppermost position. The second, third and fourth operation position buttons 32 can operate as similar as the first operation position button 32 does. The above operations of the select button 31 and the operation position buttons 32 are examples of a movement operation of a selecting position.

The operation position command or the select switch selection command is converted into an infrared signal, and the infrared signal is transmitted to the remote control sensor unit 23. The control unit 18 is configured to have a computer and includes a CPU, a ROM, a ROM and an I/O, which are connected through a bus line.

The control unit 18 has a route navigation function. For example, when a destination is input by using the operation switch group unit 17 or the remote control unit 30, the control unit 18 receives the destination via the remote control sensor unit 23. Then, the control unit 18 automatically calculates a navigation route by retrieving an optimum route inter-connecting between the present position and the destination, and causes the display unit 22 to display the navigation route.

An employed method for calculating the optimum route may utilize Dijkstra's algorithm or the like. In addition to the route guidance function, the control unit 18 outputs a signal for the device operation based on the operation position command and the select switch selection command input through the remote control sensor unit 23. For example, the control unit 18 performs the below-described select processes (A) to (E).

(A) The control unit 18 causes the display unit 22 to display the multiple switch image items over an image.

(B) The control unit 18 divides the image into multiple regions in correspondence with the multiple select witch image items. The multiple regions in the image may have different areas so that an area of each region reflects importance or frequency of use of the corresponding select switch image item.

(C) The control unit 18 obtains the operation position command through the remote control sensor unit 23. When the operation position on the image instructed by the obtained operation position command is located in one of the multiple regions, the control unit 18 causes the corresponding select switch image item to appear as being in a selectable status.

(D) The control unit 18 changes the displacement speed of the operation position on the multiple regions in accordance with an input of the movement operation. The input is transmitted from the remote control sensor unit 23.

(E) When the control unit 18 receives the select switch selection command from the remote control sensor unit 23 in a state where the select switch image item is in the selectable status, the controller determines that the select switch image item being in the selectable status is selected, and issues and outputs the device operation command to a device.

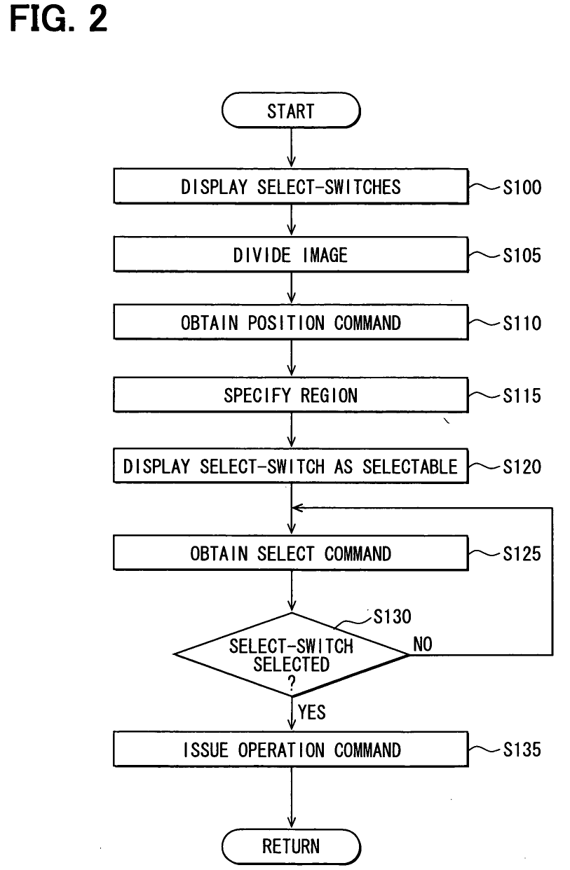

Referring to FIG. 2, a selection control procedure performed by the control unit 18 is explained below. FIG. 2 is a flow chart illustrating the selection control procedure. In the selection control procedure, the multiple select switch image items are displayed over the image by the display unit 22 at S100.

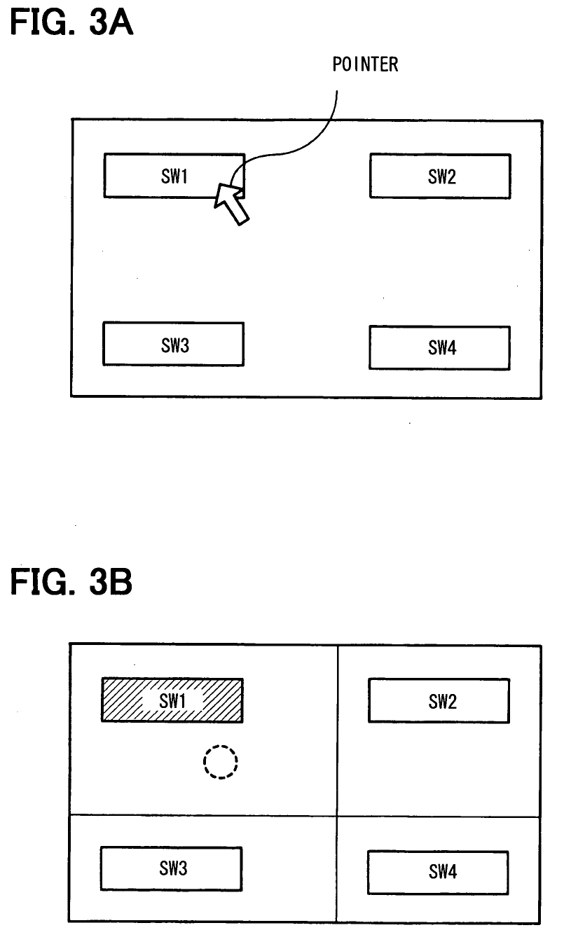

Example display of the multiple select switch image items are illustrated in FIG. 3B. In the present embodiments, as shown in FIG. 3B, four select switch image items SW1, SW2, SW3, SW4 are respectively displayed over four corner portion of the image. A dashed circle in FIG. 3B indicates the present operation position and is not actually displayed on the screen.

At S105, the image displayed by the display unit 22 is divided into multiple regions in correspondence with the select switch image items displayed at S100. As shown in FIG. 3B, the image is longitudinally and laterally divided such that the region corresponding to the select switch image item SW1 is largest and the region corresponding to the select switch image item SW4 is smallest.

At S110, the control unit 18 obtains the operation position command from the remote control sensor unit 23. At S115, based on the operation position command obtained at S110, the control unit 18 specifies an operation position existing region as corresponding to one of the multiple region.

At S120, the select switch image item displayed over the operation position existing region appears as being in a selectable status. For example, as shown in FIG. 3B, when it is determined that the operation position is located in the region corresponding to the select switch image item SW1, the display color of the select switch image item may be changed, for example, from green to red, or, the select switch image item SW1 starts blinking.

At S125, the control unit 18 obtains the select switch selection command from the remote control sensor unit 23. At S130, it is determined, based on the select switch selection command obtained at S125, whether the select switch image item is selected or not. When it is determined that the select switch image item is selected, corresponding to YES at S130, procedure proceeds to S135. When it is determined that the select switch image item is not selected, corresponding to No at S130, procedure returns to S125, and a process of determining whether the select switch image item is selected or not is repeatedly performed.

At S135, the select switch image item being a selectable status (which corresponds to SW1 in the case of FIG. 3B) is selected and an operation command associated with the selected select switch image item is issued and output.

For example, the selection of the select switch image item SW1 may correspond to an operation in which display of the display unit 22 is switched into a camera image obtained from the on-vehicle camera unit 21. In such a case, the controller outputs a command to switch the display of the display unit 22 into the camera image if the select switch image item SW1 is selected.

After finishing the process S135, procedure may finish or return to S100 for the selection control procedure to be repeatedly performed.

Characteristics of the Navigation System 1 for a Vehicle include the followings.

In the navigation system 1, the image displayed by the display unit 22 is divided into the multiple regions. When the operation position on the image is positioned in one of the multiple regions, the corresponding one of the select switch image items is distinctly displayed as being in the selectable status.

Accordingly, it is possible to display the select switch image item being in the selectable status without displaying the pointer. That is, without the pointer, a user can recognize which one is the select switch image item that is in the selectable status.

If the select switch selection command is input in the above state, the select switch image item that is in the selectable status is selected. When a user performs the movement operation in a case where one of the select switch image items is in the selectable status, the operation position is displaced. When the operation position is moved in another region, another select switch image item that corresponds to the another region appears as being in a selectable status.

Accordingly, through the following manners, a user can select the select switch image item with ease even in a case where a pointer cannot be displayed. The image is divided into the multiple regions in correspondence with the multiple select switch image items. When the operation position is positioned in one of the regions, the select switch image item corresponding to the one of the region is displayed so as to appear as being in a selectable status.

In accordance with the user's movement operation of the selecting position, the remote control unit 30 changes the displacement speed of the operation position on the image over which the select switch image items are displayed. The operation position command instructs the displacement speed. The control unit 18 changes the displacement speed of the operation position on the regions of the image in accordance with a value associated with the movement operation, the value being input from the remote control unit 30 via the remote control sensor unit 23. Accordingly, a selection operation for the select switch image items can be performed in accordance with a user operation.

That is, in accordance with a user operation, the operation position can slowly or quickly move to enter into another region. The select switch image item can be selected in a quick manner or a slow manner.

The regions of the image have different areas so that an area of each region reflects one of an importance and a frequency of use of the corresponding select switch image item. Therefore, a use can quickly select his or her target select switch image item since the operation position can speedily enter the corresponding region.

### MODIFICATION EXAMPLES

According to the above embodiments, the operation position command and the select switch selection command are converted into an infrared signal. Alternatively, the commands may be converted into a radio signal.

According to the above embodiments, for an operation of the remote control unit 30, the remote control unit 30 has a select button 31 and operation position buttons 32 located on the right side, the left side, the top side and the bottom side of the select button 31. Alternatively, a joy stick may be used in place of the operation position buttons 32.

A rate of movement of the operation position may vary in accordance with the magnitude of tilt of the joystick. In the above manner, when the joy stick is kept tilted for the operation position to move, the operation position may move gradually. When the joystick is quickly tilted in a movement direction and then instantly returned in a neutral position, the operation position may instantaneously move into a movement-directed region. The above operations of the joystick are examples of a movement operation of a selecting position.

According to the above embodiments, the navigation system 1 for a vehicle is remote-controlled by the remote control apparatus 5. Alternatively, another system or another apparatus may be remote-controlled by the remote control apparatus 5. For example, audio device for a vehicle or a driving assistance system may be remote-controlled.

According to an aspect of the above-described embodiments, a remote control apparatus 5 is provided that includes a display unit 22, a remote control unit 30, a receiving unit 23, and a controller 18.

The display unit 22 is capable of displaying an image and a multiple select switch image items each to be selected for a device operation. The remote control unit 30 is configured to issue an operation position command and a select switch selection command in accordance with a user's movement operation of a selecting position. The operation position command instructs an operation position on the image displayed by the display unit. The select switch selection command instructs a selection operation for selecting a target select switch image item from among the multiple select switch image items.

The receiving unit 23 is configured to receive the operation position command and the select switch selection command from the remote control unit 30. The controller 18 is configured to issue a device operation command based on the operation position command and the select switch selection command input from the receiving unit 23.

The controller 18 is configured to causes the display unit 22 to display the multiple select switch image items over the image, and configured to divide the image into multiple regions in correspondence with the multiple select switch image items. The controller is configured to obtain the operation position command through the receiving unit 23, configured to specify an operation position existing region as corresponding to one of the multiple regions that the operation position instructed by the operation position command is positioned in, and configured to cause one of the multiple select switch image items corresponding to the operation position existing region to appear as being in a selectable status. When the controller 18 receives the select switch selection command through the receiving unit 23 in a state where the one of the multiple select switch image items corresponding to the operation position existing region appears as being in a selectable status, the controller 18 is configured to determine that the one of the multiple select switch image items is selected and the controller 18 is configured to issue the device operation command.

According to the above remote control apparatus 5, a user can operate a device through the remote control apparatus by selecting the target select switch image item from among the multiple select switch image items displayed by the display unit 22. In the above case, the user can perform the selection operation with ease, without displaying a pointer indicating a position for operation on the image.

In a conventional remote control apparatus, as shown in FIG. 3A, multiple switch image items are displayed on an image, and a pointer is displayed to indicate a position for operation on the image. The select switch image item is determined to be selected when a selection operation such as clicking is carried out in a state where the pointer is placed over the select switch image item.

When it is not possible to display the pointer due to, for example, the above-described reason, a user cannot recognize a position for operation on the image. In such a case, it is difficult to select the select switch image item.

In the remote control apparatus according to one embodiment, the image displayed on the display means 5 is divided into multiple regions in correspondence with the multiple select switch image items. When the operation position on the image is located in one of the regions, the select switch image item that corresponds to the one of the regions is displayed such that the select switch image item is in a selectable status.

Without a pointer being displayed, it is possible to display one of the multiple select switch image items as being in a selectable status. That is, without a pointer, a user can find which one is the elect switch image item that is currently in a selectable status.

When the select switch selection command is inputted in the above status, the select switch image item that is in a selectable status is selected. If a user performs an movement operation in a state where one of the multiple select switch image items is in a selectable status, the operation position is moved. In such a case, if the operation position enter another region, another one of the multiple select switch image item corresponding to the another region is displayed as being in a selectable status.

As described above, even when it is not possible to display the pointer, a user is allowed to easily select a select witch image item from among the multiple select switch image items in such a manner: an image is divided into multiple region in correspondence with multiple select switch image items; and, when the operation position exists in one of the regions, the select switch image item that corresponds to the operation position existing region is displayed as being in a selectable status.

The phrase “in accordance with a movement operation” may mean a phrase “in accordance with content of user's movement operation such as an operating speed of the movement operation and the number of movement operations. In a conventional remote control apparatus employing that displays a pointer, when a user attempts to select a select switch image item, the user typically places the pointer over an select switch image item while watching a position of the pointer.

The above remote control apparatus according to the present disclosure may be configured such that: the remote control unit change a first instruction of the operation position command; the first instruction instructs a displacement speed of the operation position on the image; the displacement speed is changeable in accordance with the user's movement operation of the selecting position; and the controller is configured to change the displacement speed of the operation position on the multiple regions in accordance with the first instruction of the operation position command. Through the above manners, the selection operation for selecting the target select switch image item can be performed in accordance with an operation by a user.

For example, when a joy stick is kept tilted for the operation position to move, the operation position may move slowly. When the joy stick is instantly tilted in a movement direction and then quickly returned at a natural position, the operation position may instantly move into a region located in a movement direction of the operation position.

In accordance with the user's operation, since it is possible to slowly move the operation position or instantly move into the region, it is possible to select the target select switch image item quickly or slowly.

The multiple select switch image items may have one with a high importance or a low importance and may have one with a high frequency of use or a low frequency of use. It may be convenient when a user can easily select one or ones with a high importance or with a high frequency of use.

The above remote control apparatus according to the present disclosure may be configured such that: the controller is configured to divide the image into the multiple regions in correspondence with the multiple select switch image items so that the multiple regions has different areas; and the area of each of the multiple regions depends on one of an importance of the corresponding one of the multiple select witch image items and a frequency of use of the corresponding one of the multiple select witch image items.

According to the above configuration, it is possible to divide the image so that one or ones of the regions corresponding to the select switch image item with a high importance or a high frequency use has a large area. In such a case, the operation position can quickly move into the one or ones of the regions, and thus the selection operation can be conveniently performed.

While the invention has been described above with reference to various embodiments thereof, it is to be understood that the invention is not limited to the above described embodiments and construction. The invention is intended to cover various modification and equivalent arrangements. In addition, while the various combinations and configurations described above are contemplated as embodying the invention, other combinations and configurations, including more, less or only a single element, are also contemplated as being within the scope of embodiment.

What is claimed is:

1. A remote control apparatus comprising:
a display unit capable of displaying an image and a plurality of select switch image items each to be selected for a device operation;
a remote control unit configured to issue an operation position command and a select switch selection command in accordance with a user's movement operation of a selecting position, wherein the operation position command instructs an operation position on the image displayed by the display unit, wherein the select switch selection command instructs a selection operation for selecting a target select switch image item from among the plurality of select switch image items;
a receiving unit configured to receive the operation position command and the select switch selection command from the remote control unit; and
a controller configured to issue a device operation command based on the operation position command and the select switch selection command inputted from the receiving unit, wherein:
the controller is configured to causes the display unit to display the plurality of select switch image items over the image, and configured to divide the image into a plurality of regions in correspondence with the plurality of select switch image items;
the controller is configured to obtain the operation position command via the receiving unit, configured to specify an operation position existing region as corresponding to one of the plurality of regions that the operation position is positioned in, and configured to cause one of the plurality of select switch image items corresponding to the operation position existing region to appear as being in a selectable status; and
when the controller receives the select switch selection command through the receiving unit in a state where the one of the plurality of select switch image items corresponding to the operation position existing region appears as being in a selectable status, the controller is configured to determine that the one of the plurality of select switch image items is selected and the controller is configured to issue the device operation command.

2. The remote control apparatus according to claim 1, wherein:
the remote control unit change a first instruction of the operation position command, the first instruction instructing a displacement speed of the operation position on the image, the displacement speed being changeable in accordance with the user's movement operation of the selecting position; and
the controller is configured to change the displacement speed of the operation position on the plurality of regions in accordance with the first instruction of the operation position command.

3. The remote control apparatus according to claim 1, wherein:
the controller is configured to divide the image into the plurality of regions in correspondence with the plurality of select switch image items so that the plurality of regions has different areas; and
the area of each of the plurality of regions depends on one of an importance and a frequency of use of the corresponding one of the plurality of select switch image items.

4. The remote control apparatus according to claim 1, wherein
the remote control unit is configured to transmit a signal including the operation position command and the select switch selection command to the receiving unit in a wireless manner.

5. A remote control apparatus for an in-vehicle system, the remote control apparatus comprising:
a display unit having a screen capable of displaying an image and a plurality of menu items;
a remote control unit having an input interface capable of receiving an input operation, wherein the remote control unit is configured to outputs a remote control signal that depends on the input operation;
a receiving unit configured to receive the remote control signal from the remote control unit and outputs the remote control signal; and
a controller configured to receive the remote control signal from the receiving unit, configured to control display on the screen of the display unit, and capable of outputting a system control signal for controlling the in-vehicle system based on the remote control signal, wherein:
the controller is configured to cause the display unit to display the image;
the controller is configured to cause the display unit to display the plurality of menu items over the image;
the controller is configured to set a virtual coordinate system for specifying a position on the image, and set a virtual operation point that has a position on the virtual coordinate system, wherein the virtual operation point is movable on the virtual coordinate system in accordance with the remote control signal;
the controller is configured to specify a position of each menu item on the virtual coordinate system;
the controller is configured to partition the virtual coordinate system into a plurality of regions so that the plurality of menu items is respectively positioned in the plurality of regions;
the controller is configured to specify an operation point existing region as corresponding to one of the plurality of regions that the virtual operation point is positioned in;
the controller is configured to cause the display unit to display one of the plurality of menu items that corresponds to the operation point existing region as being in a selectable status; and
the controller is configured to issue the system control signal when the one of the plurality of menu items is in the selectable status and when the remote control signal indicates that the input interface receives a predetermined input operation.
